(19) United States
(12) Patent Application Publication
(10) Pub. No.: US 2026/0339252 A1
(43) Pub. Date: Oct. 29, 2026

(54) IMAGE FORMING APPARATUS

(71) Applicant: CANON KABUSHIKI KAISHA, Tokyo (JP)

(72) Inventor: YUYA NAGATOMO, Ibaraki (JP)

(21) Appl. No.: 19/641,295

(22) Filed: Apr. 7, 2026

(30) Foreign Application Priority Data
Apr. 28, 2025 (JP) 2025-074981

(51) Int. Cl. G03G 15/00; G03G 15/02

(52) U.S. Cl. CPC G03G 15/553; G03G 15/0216; G03G 15/5016

(57) ABSTRACT

Provided is an image forming apparatus in which in a case where a first unit is mounted on a mounting portion, an application unit applies a voltage to a first charging member, and a controller controls a display to display information related to replacement of the first unit based on information related to calculation of a first lifetime value of the first unit and information related to an operation of the first unit, and in a case where a second unit is mounted on the mounting portion, the application unit applies a voltage to a second charging member, and the controller controls the display to display information related to replacement of the second unit based on information related to calculation of a second lifetime value of the second unit and information related to an operation of the second unit.

### BACKGROUND

### Field of the Technology

The aspect of the embodiments relates to an image forming apparatus on which a photoconductor unit is mountable.

### Description of the Related Art

US2020/0341402 describes a structure in which a photoconductor unit including a photoconductor drum and a charging roller that charges the photoconductor drum is detachably attachable to an image forming apparatus.

Japanese Patent Laid-Open No. 2012-98532 describes a structure in which a plurality of types of photoconductor drums (process cartridges) are mountable on an image forming apparatus, the lifetimes of the photoconductor drums being made different by forming photoconductive layers of the photoconductor drums out of different materials.

In a structure in which a plurality of types of photoconductor units having different lifetimes are mountable on an image forming apparatus, the lifetimes of the photoconductor units that are mounted on the image forming apparatus need to be estimated based on the photoconductor units.

### SUMMARY

An aspect of the embodiments is to provide an image forming apparatus including a mounting portion on which a first unit and a second unit are mountable, the first unit including a first member on which a first latent image is to be formed, a first charging member that charges the first member, and a first storage unit, the second unit including a second member on which a second latent image is to be formed, a second charging member that charges the second member, and a second storage unit; an application unit; a display; and a controller that controls the display. The first storage unit stores first information related to calculation of a first lifetime value of the first unit, and the second storage unit stores second information related to calculation of a second lifetime value of the second unit. In a case where the first unit is mounted on the mounting portion, the application unit applies a voltage to the first charging member, and the controller controls the display to display information related to replacement of the first unit based on the first information stored in the first storage unit and information related to a first operation of the first unit, and in a case where the second unit is mounted on the mounting portion, the application unit applies a voltage to the second charging member, and the controller controls the display to display information related to replacement of the second unit based on the second information stored in the second storage unit and information related to a second operation of the second unit.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view showing a structure of an image forming apparatus according to a first embodiment.

FIG. 2 is a cross-sectional view showing a structure of one image forming unit according to the first embodiment.

FIG. 3 is a cross-sectional view showing a structure of one photoconductor unit according to the first embodiment.

FIG. 4 is a block diagram showing a part of a control system of the image forming apparatus according to the first embodiment.

FIG. 5 is a flow chart showing a series of steps related to obtaining inherent information related to calculation of lifetime values of photoconductor units according to the first embodiment.

FIG. 6 is a flow chart showing a series of steps related to detecting the lifetimes of the photoconductor units according to the first embodiment.

FIG. 7 is a flow chart showing a series of steps related to obtaining inherent information related to calculation of lifetime values of photoconductor units according to a second embodiment.

FIG. 8 is a flow chart showing a series of steps related to defecting the lifetimes of the photoconductor units according to the second embodiment.

### DESCRIPTION OF THE EMBODIMENTS

Embodiments of the disclosure are described in detail below with reference to the attached drawings. It should be noted that the embodiments below do not limit the disclosure according to the claims, and that not all combinations of features that are described in the embodiments of the disclosure are required as solutions for the disclosure.

The disclosure can be carried out in various applications, such as printers, various printing devices, copying machines, facsimiles, or multifunction devices.

### First Embodiment

### Structure of Image Forming Apparatus

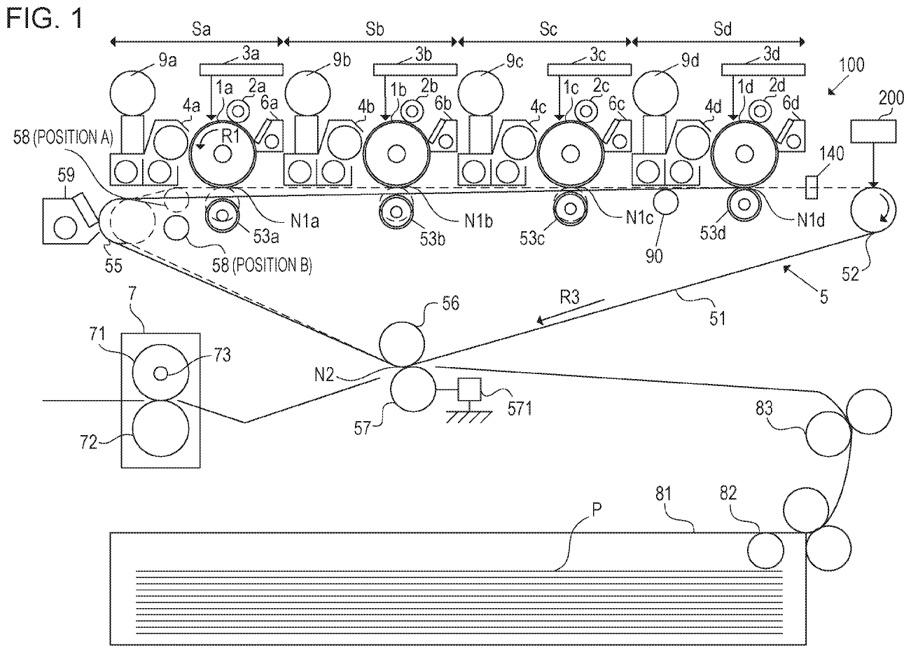

First, a structure and an operation of an entire image forming apparatus are described. FIG. 1 is a cross-sectional view showing a structure of an image forming apparatus 100 according to a first embodiment.

The image forming apparatus 100 includes four photoconductor drums 1, and is a full-color electrophotographic image forming apparatus using an intermediate transfer system. In the embodiment, a process speed corresponding to a surface moving speed of each photoconductor drum 1 and an intermediate transfer belt 51 is 150 mm/sec.

The image forming apparatus 100 includes, as a plurality of image forming units, first, second, third, and fourth image forming units Sa, Sb, Sc, and Sd. The image forming units Sa, Sb, Sc, and Sd are units for forming images of respective colors, that is, yellow (Y), magenta (M), cyan (C), and black (Bk). It should be noted that, in one embodiment, the structures of the image forming units Sa to Sd are essentially the same except that they use toners of different colors. Therefore, when they need not be particularly distinguished, they will be generally described by omitting the letters, a, b, c, and d, added to the reference numerals in the figures for indicating that they are units provided for a corresponding one of the colors.

The image forming units S include the photoconductor drums 1 as image carriers. For example, a charging roller 2, serving as a primary charging unit, a laser scanner 3, serving as an exposure unit, a developing device 4, serving as a developing unit, and a drum cleaner 6, serving as a drum cleaning unit, are successively disposed around each photoconductor drum 1 along a direction of rotation of each photoconductor drum 1. The intermediate transfer belt 51, which is a belt member serving as an intermediate transfer member and capable of circular movement, is disposed adjacent to the photoconductor drums 1a to 1d of the respective image forming units Sa to Sd.

The intermediate transfer belt 51 is placed upon a driving roller 52, a steering roller 55, a secondary inner transfer roller 56, and an upstream regulating roller 58, which serve as a plurality of supporting members. The steering roller 55 also has the function of applying a tension force for supporting the intermediate transfer belt 51 in a tensioned state, and two ends of the steering roller 55 are urged in a substantially leftward direction in FIG. 1 by a spring urging unit (not shown). The driving roller 52, serving as a belt driving unit, transmits a driving force to the intermediate transfer belt 51 and causes the intermediate transfer belt 51 to move in a circular manner in the direction of arrow R3 shown in FIG. 1.

Primary transfer rollers 53a to 53d, serving as primary transfer members, are disposed at positions opposite to the respective photoconductor drums 1a to 1d on an inner peripheral surface side of the intermediate transfer belt 51. The primary transfer rollers 53a to 53d are urged toward the respective photoconductor drums 1a to 1d with the intermediate transfer belt 51 being interposed therebetween, and primary transfer portions (primary transfer nips) N1a to N1d where the photoconductor drums 1a to 1d and the intermediate transfer belt 51 contact each other are formed.

A secondary outer transfer roller 57, serving as a secondary transfer member, is disposed at a position opposite to the secondary inner transfer roller 56 on an outer peripheral surface side of the intermediate transfer belt 51. The secondary outer transfer roller 57 contacts the outer peripheral surface of the intermediate transfer belt 51, and a secondary transfer portion (a secondary transfer nip) N2 is formed. Images on the photoconductor drums 1a to 1d that have been formed by the respective image forming units Sa to Sd are successively transferred in a multiple manner to the intermediate transfer belt 51 that is adjacent to and moves and passes the photoconductor drums 1a to 1d. Then, the images transferred to the intermediate transfer belt 51 are further transferred to a transfer medium P, such as paper, at the secondary transfer portion N2.

A fixing device 7 includes a fixing roller 71 that is rotatably disposed and a pressing roller 72 that rotates while press-contacting the fixing roller 71. A heater 73, such as a halogen lamp, is disposed in the fixing roller 71. By controlling, for example, a voltage that is supplied to the heater 73, the temperature of the surface of the fixing roller 71 is adjusted. When the transfer medium P is conveyed to the fixing device 7, the transfer medium P passes between the pressing roller 72 and the fixing roller 71 that rotate at a constant speed, during which the transfer medium P is pressurized and heated under a substantially constant pressure and temperature from both front and back surfaces of the transfer medium P. This causes unfixed toner images on the front surface of the transfer medium P to fused and fixed to the transfer medium P.

In this way, a full-color image is formed on the transfer medium P.

### Structures of Image Forming Units

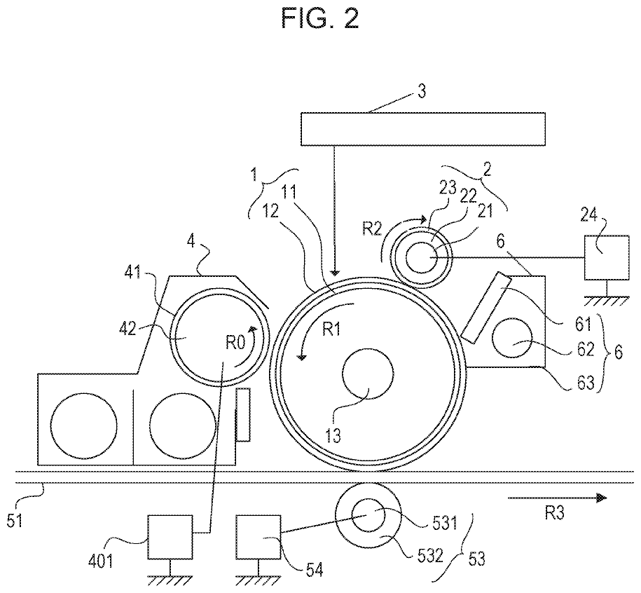

Next, the image forming units S are described in detail. FIG. 2 is a cross-sectional view showing a structure of one image forming unit S according to the first embodiment.

Each photoconductor drum 1 is rotatably supported by an apparatus main body of the image forming apparatus 100.

Each photoconductor drum 1 is a cylindrical electrophotographic photoconductor member whose basic structure includes an electroconductive base member 11 that is made of, for example, aluminum, and a photoconductive layer 12 that is formed at an outer periphery of the photoconductor drum 1. Each photoconductor drum 1 includes a supporting shaft 13 at the center of the photoconductor drum 1. Each photoconductor drum 1 is rotationally driven by a driving unit in the direction of arrow R1 shown in FIG. 2 upon the supporting shaft 13 as the center. In the embodiment, although organic optical semiconductor photoconductor drums having a diameter of φ30 are used, amorphous silicon photoconductor drums may also be used.

As shown in FIG. 2, the charging roller 2 (charging member), serving as a primary charging unit, is disposed above the photoconductor drum 1. The charging roller 2 contacts the surface of the photoconductor drum 1 and uniformly charges the surface of the photoconductor drum 1 to a predetermined polarity and electrical potential. The charging roller 2 includes an electrically conductive cored bar 21 that is disposed in the center of the charging roller 2, a low-resistance electrically conductive layer 22 that is formed at an outer periphery of the charging roller 2, and a medium-resistance electrically conductive layer 23, and has the shape of a roll as a whole.

The charging roller 2 is rotatably supported by a bearing member at two end portions of the cored bar 21, and is disposed parallel to the photoconductor drum 1. The bearing member at the two end portions of the cored bar 21 is urged toward the photoconductor drum 1 by a pressing unit. This causes the charging roller 2 to press-contact the surface of the photoconductor drum 1 by a predetermined pressing force.

As shown in FIG. 2, as the photoconductor drum 1 rotates in the direction of arrow R1, the charging roller 2 is driven and rotated in the direction of arrow R2. A charging bias voltage (a high voltage) is applied to the charging roller 2 by a charging bias power source 24 (a voltage application unit), serving as a charging bias output unit. In the embodiment, the surface of the photoconductor drum 1 is uniformly charged to −600 V by the charging roller 2.

The laser scanner 3 is disposed on a downstream side of the charging roller 2 in the direction of rotation of the photoconductor drum 1. The laser scanner 3 scans the surface of the photoconductor drum 1 while turning off and on laser light based on image information, and exposes the surface of the photoconductor drum 1. This causes an electrostatic image (a latent image) based on the image information to be formed on the surface of the photoconductor drum 1. The wavelength of the laser scanner 3 used in the embodiment is λ=780 nm, and the resolution of the laser scanner 3 is 600 dpi.

The developing device 4 is disposed on a downstream side of the laser scanner 3 in the direction of rotation of the photoconductor drum 1. The developing device 4 makes visible the electrostatic image formed on the photoconductor drum 1.

The developing device 4 has a development region that faces the photoconductor drum 1 and that has an opening portion, and a developing sleeve 41 is rotatably disposed such that a part thereof is exposed at the opening portion. At the time of a development operation, the developing sleeve 41 that internally includes a fixed magnet 42, serving as a magnetic field generating unit, rotates in the direction of the illustrated arrow R0, holds in the form of a layer a developer provided in a developer container, and carries and conveys the developer to the development region. Then, the developing sleeve 41 supplies the developer to the development region facing the photoconductor drum 1, and develops with toner the electrostatic latent image formed on the photoconductor drum 1. At this time, a suitable development bias voltage is applied to the developing sleeve 41, and, in the embodiment, a voltage in which an alternating-current component having a frequency of 10 kHz and a peak-to-peak voltage Vpp of 1.8 kV and a direct-current component (Vdc) having a voltage of −450 V are superposed upon each other is applied from a high voltage power source.

As shown in FIG. 2, the primary transfer roller 53 is disposed below the photoconductor drum 1 on a downstream side of the development region in the direction of rotation of the photoconductor drum 1. The primary transfer roller 53 includes a cored bar 531 and an electrically conductive layer 532 that has a cylindrical shape and that is formed around an outer peripheral surface of the cored bar 531. The primary transfer roller 53 is urged toward the photoconductor drum 1 at two end portions thereof by a pressing member, such as a spring. This causes the electrically conductive layer 532 of the primary transfer roller 53 to press-contact the surface of the photoconductor drum 51 by a predetermined pressing force with the intermediate transfer belt 51 being interposed therebetween. A primary transfer bias power source 54, serving as a primary transfer bias output unit, is connected to the cored bar 531.

The primary transfer portion N1 is formed between the photoconductor drum 1 and the primary transfer roller 53. At the primary transfer portion N1, the intermediate transfer belt 51 is interposed between the photoconductor drum 1 and the primary transfer roller 53. The primary transfer roller 53 contacts the inner peripheral surface of the intermediate transfer belt 51 and rotates as the intermediate transfer belt 51 moves. At the time of image formation, a primary transfer bias voltage having an opposite polarity (second polarity: in the embodiment, a positive polarity) to a normal charging polarity (first polarity: in the embodiment, a negative polarity) of toner is applied to the primary transfer roller 53 by the primary transfer bias power source 54. Then, an electric field in the direction in which the toner having the first polarity moves toward the intermediate transfer belt 51 from the surface of the photoconductor drum 1 is formed between the primary transfer roller 53 and the photoconductor drum 1. This causes a toner image formed on the surface of the photoconductor drum 1 to be transferred (primary-transferred) to a surface of the intermediate transfer belt 51.

An adhering substance, such as residual toner (primary transfer residual toner) on the surface of the photoconductor drum 1 after a primary transfer process is cleaned off by the drum cleaner 6 (cleaning device). The drum cleaner 6 includes a cleaning blade 61, serving as a drum cleaning member, a conveying screw 62, and a drum cleaner housing 63. A pressing unit causes the cleaning blade 61 to contact the photoconductor drum 1 at a predetermined angle and pressure. This causes, for example, the residual toner on the surface of the photoconductor drum 1 to be scraped off and removed from the surface of the photoconductor drum 1 by the cleaning blade 61, and to be collected into the drum cleaner housing 63. For example, the collected toner is conveyed by the conveying screw 62 and discharged to a residual toner container.

### Structure of Photoconductor Unit

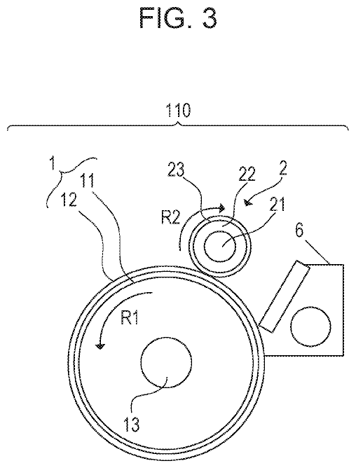

Next, a photoconductor unit 110 is described in detail with reference to FIG. 3. FIG. 3 is a cross-sectional view showing a structure of one photoconductor unit 110 according to the first embodiment.

As shown in FIG. 3, the photoconductor unit 110 is one in which the photoconductor drum 1 (photoconductor member), the charging roller 2 (charging member), and the drum cleaner 6 (cleaning device) are collectively unitized.

Photoconductor units 110 are detachably attachable (mountable) to predetermined positions (mounting portions) of the respective image forming units Sa to Sd. The photoconductor units 110 are provided with photoconductor unit memories, serving as storage units, for respective colors.

As the storage units of the photoconductor units 110, it is possible to use, in addition to non-volatile memories, for example, IC chips or barcodes, and in one embodiment, the storage units are to be automatically readable by an information reading unit of the image forming apparatus 100. In the embodiment, photoconductor unit memories 25, which are examples of the storage units of the photoconductor units 110, are installed at rear faces of the respective photoconductor units 110 (rear sides of the main body), and data can be read and written from a controller (CPU) of the image forming apparatus 100. The controller (CPU) of the image forming apparatus 100 is formed so as to be capable of communicating with the photoconductor unit memories 25 when the photoconductor units 110 are mounted on the image forming apparatus 100.

The photoconductor unit memories 25 store pieces of inherent information based on life values (lifetime values) of the photoconductor units 110 (pieces of inherent information related to calculation of the lifetime values of the photoconductor units 110).

In the first embodiment, as the pieces of inherent information related to the calculation of the lifetime values of the photoconductor units 110, at least the values mentioned below are stored at the stage of producing the photoconductor units 110.

Coefficients α that indicate the relationships between integrated charging distances Lc, through which the photoconductor drums 1 are charged by the respective charging rollers 2, and wear amounts of the photoconductor drums 1 are stored in the respective photoconductor unit memories 25.

Coefficients β that indicate the relationships between values (Ld−Lc) and the wear amounts of the photoconductor drums 1 are stored in the photoconductor unit memories 25, the values (Ld−Lc) being obtained by subtracting the integrated charging distances Lc, through which the photoconductor drums 1 are charged, from integrated driving distances Ld, through which the photoconductor drums 1 are driven. It should be noted that the values (Ld−Lc), obtained by subtracting the integrated charging distances Lc, through which the photoconductor drums 1 are charged, from the integrated driving distances Ld, through which the photoconductor drums 1 are driven, refer to distances through which the photoconductor drums 1 rotate when charging voltages are not applied to the photoconductor drums 1.

Usable surface-layer film thicknesses of the photoconductor drums 1 are stored in the photoconductor unit memories 25.

These values are based on the lifetime values of the photoconductor units 110, and are previously determined by experiments. With regard to photoconductor units 110 having the same structures with regard to the lifetime values, such values stored in the respective photoconductor unit memories 25 are the same.

When a new photoconductor unit 110 has been mounted on the image forming apparatus 100, the aforementioned pieces of information stored in the photoconductor unit memories 25 are read by the information reading unit of the image forming apparatus 100. Based on the pieces of information that have been read, the controller (CPU) of the image forming apparatus 100 calculates an estimation of the lifetime of the photoconductor unit 110 that has been mounted on the image forming apparatus 100.

### Control System of Image Forming Apparatus

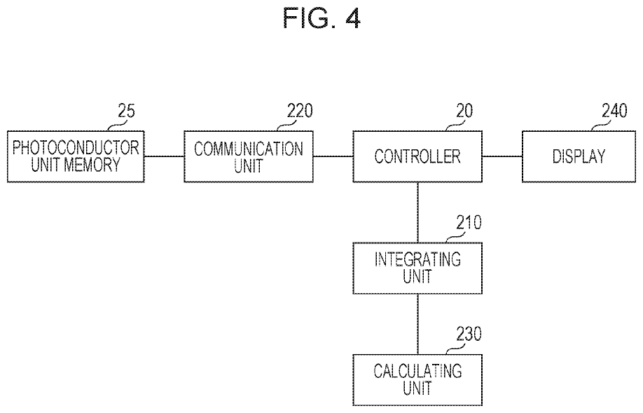

Next, a control system of the image forming apparatus 100 is described in detail. FIG. 4 is a block diagram showing a part of the control system of the image forming apparatus 100 according to the first embodiment.

As shown in FIG. 4, an integrating unit 210, a communication unit 220, a calculating unit 230, a display 240 (display unit), and the photoconductor unit memories 25 (storage units) are connected to a controller 20 (CPU) of the image forming apparatus 100.

The communication unit 220 communicates with the photoconductor unit memories 25, reads the pieces of information stored in the photoconductor unit memories 25, and transfers the read pieces of information to the controller 20.

The calculating unit 230 calculates the distances through which the photoconductor drums 1 are rotationally driven (hereunder referred to as “photoconductor-drum-1 driving distances”). The calculating unit 230 also calculates the distances through which charging bias voltages (high voltages) are applied to the charging rollers 2 by the charging bias power sources 24 (hereunder referred to as “high-voltage-applied charging-roller-2 distances”).

The integrating unit 210 calculates values obtained by integrating the photoconductor-drum-1 driving distances obtained by the calculating unit 230 (hereunder referred to as “photoconductor-drum-1 integrated driving distances Ld”). The integrating unit 210 also calculates values obtained by integrating the high-voltage-applied charging-roller-2 distances obtained by the calculating unit 230 (hereunder referred to as “photoconductor-drum-1 integrated charging distances Lc”). It should be noted that the high-voltage-applied charging-roller-2 distances refer to charging distances through which the surfaces of the photoconductor drums 1 are charged by the charging rollers 2.

The controller 20 can cause the photoconductor unit memories 25 to store pieces of information about, for example, the photoconductor-drum-1 integrated driving distances Ld and the photoconductor-drum-1 integrated charging distances Lc, obtained by the integrating unit 210.

The controller 20 controls the display 240 to display various types of information such as information related to the lifetimes of the photoconductor units 110 (for example, information about how close the photoconductor units 110 are to the ends of their lifetimes, and notification prompting replacement of the photoconductor units 110). This causes the display 240 to display various types of information such as information related to the lifetimes of the photoconductor units 110.

### Method of Detecting Lifetimes of Photoconductor Units

Here, a method of detecting the lifetimes of the photoconductor units 110 according to the first embodiment is described. In the first embodiment, the lifetimes of the photoconductor units 110 are detected by estimating wear amounts of the photoconductor drums 1.

The method of detecting the lifetimes of the photoconductor units 110 may be a method of estimating the lifetimes by using, for example, information about the distances through which the photoconductor drums 1 are rotationally driven, information about the high-charging-voltage-applied charging-roller-2 distances, or information about the number of image formations (number of prints) using transfer media P.

The wear amount of each photoconductor drum 1 is calculated by using the photoconductor-drum-1 integrated driving distance Ld, the photoconductor-drum-1 integrated charging distance Lc, and the coefficients (α, β) stored in each photoconductor unit memory 25.

The usable surface-layer film thicknesses are previously determined for the photoconductor drums 1, and when the calculated wear amounts of the photoconductor drums 1 reach usable film thickness values, the photoconductor units 110 are determined as having reached the ends of their lifetimes.

As described above, in the first embodiment, the coefficients α that indicate the relationships between the integrated charging distances Lc, through which the photoconductor drums 1 are charged, and the wear amounts of the photoconductor drums 1 are stored in the respective photoconductor unit memories 25. The coefficients α indicate the wear rates of the photoconductor drums 1 to the photoconductor-drum-1 driving distances when high charging voltages are applied to the photoconductor drums 1.

In the first embodiment, the coefficients β that indicate the relationships between the values (Ld−Lc) and the wear amounts of the photoconductor drums 1 are stored in the photoconductor unit memories 25, the values (Ld−Lc) being obtained by subtracting the integrated charging distances Lc, through which the photoconductor drums 1 are charged, from the integrated driving distances Ld, through which the photoconductor drums 1 are driven. The coefficients β indicate the wear rates of the photoconductor drums 1 to the photoconductor-drum-1 driving distances when high charging voltages are not applied to the photoconductor drums 1.

In the first embodiment, usable surface-layer film thickness values T of the photoconductor drums 1 are stored in the photoconductor unit memories 25.

The coefficients that are stored in the photoconductor unit memories 25 are such that values written to the photoconductor unit memories 25 are determined based on structures related to the wear amounts of the photoconductor drums 1 of the photoconductor units 110. The structures related to the wear amounts of the photoconductor drums 1 are, for example, the surface-layer materials and the film thicknesses of the photoconductor drums 1, and the materials and the contact pressures of the cleaning blades 61.

Life (LFd) values that indicate the states of use of the photoconductor drums 1 (photoconductor-unit-110 lifetime values) are defined by the following Formula 1:

LFd={α×Lc+β×(Ld−Lc)}/T×100[%]. . . (1)

Here, Ld−Lc is a value obtained by subtracting the integrated charging distance Lc, through which each photoconductor drum 1 is charged, from the integrated driving distance Ld, through which each photoconductor drum 1 is driven, and indicates the distance through which each photoconductor drum 1 rotates when a charging voltage is not applied to each photoconductor drum 1.

That is, α×Lc indicates the wear amount of each photoconductor drum 1 determined by the distance through which a high charging voltage is applied to each photoconductor drum 1. β×(Ld−Lc) indicates the wear amount of each photoconductor drum 1 determined by the rotation distance of each photoconductor drum 1 rotates when a high charging voltage is not applied to each photoconductor drum 1. The sum of these values, that is, α×Lc+β×(Ld−Lc) becomes the wear amount of each photoconductor drum 1, and the proportion of the wear amount of each photoconductor drum 1 to the usable surface-layer film thickness of each photoconductor drum 1 is the life (LFd) value that indicates the state of use of each photoconductor drum 1.

In the first embodiment, when LFd=100[%], the controller 20 (CPU) determines that the end of the lifetime of each photoconductor unit 110 has been reached, and the display unit 240 displays a warning (notification prompting replacement of each photoconductor unit 110).

As described above, all required pieces of information other than the pieces of information related to the operations of the photoconductor units 110 (the integrated driving distances Ld, through which the photoconductor drums 1 are driven, and the integrated charging distances Lc, through which the photoconductor drums 1 are charged) are previously stored in the photoconductor unit memories 25. When producing the photoconductor units 110, by adjusting the values written to the photoconductor unit memories 25 (inherent information related to the calculation of the lifetime values of the photoconductor units 110), it is possible to estimate proper lifetimes based on the lifetime values of the photoconductor units 110.

Here, the adjustment of the values written to the photoconductor unit memories 25 (inherent information related to the calculation of the lifetime values of the photoconductor units 110) is described by way of specific examples.

For general OPC drums, the wear rates of the photoconductor drums 1 tend to be higher when high charging voltages are applied to the photoconductor drums 1 than when high charging voltages are not applied to the photoconductor drums 1 (α>β). That is, the wear rates α of the photoconductor drums 1 to the photoconductor-drum-1 driving distances when high charging voltages are applied to the photoconductor drums 1 are higher than the wear rates β of the photoconductor drums 1 to the photoconductor-drum-1 driving distances when high charging voltages are not applied to the photoconductor drums 1.

The ratio of the wear rate α of each photoconductor drum 1 to the wear rate β of each photoconductor drum 1 is expressed by α/β. For example, the α and β values are stored in the photoconductor unit memories 25 such that the ratio of the wear rates of each photoconductor drum 1 becomes α/β=1.25.

It is supposed that, after producing and shipping the image forming apparatus 100, in order to further increase the lifetime of each photoconductor unit 110, the design of each photoconductor unit 110 has been changed such that the surface layer of each photoconductor drum 1 is a high hardness layer. When the surface-layer hardness of each photoconductor drum 1 increases, the wear rate of each photoconductor drum 1 as a whole decreases. In particular, the wear rate β of each photoconductor drum 1 when a high charging voltage is not applied to each photoconductor drum 1 further decreases. For example, the α and β values are stored in each photoconductor unit memory 25 such that the ratio of the wear rates of each photoconductor drum 1 is α/β=4.

When producing the photoconductor units 110, the values written to the photoconductor unit memories 25 are adjusted such that α and β are smaller than those before changing the designs of the photoconductor units 110 and such that the ratio α/β of the wear rates of each photoconductor drum 1 is larger than that before changing the designs. Therefore, before and after changing the designs of the photoconductor units 110, even if the lifetime values of the photoconductor drums 1 change considerably, the precision of estimating the lifetimes of the photoconductor drums 1 can be increased.

This example is merely an example, and, as described above, by changing, for example, the surface-layer film thicknesses of the photoconductor drums 1 or the materials or the contact pressures of the cleaning blades 61, the lifetime values of the photoconductor units 110 can be changed. For example, when the lifetimes of the photoconductor units 110 are to be changed by changing the surface-layer film thicknesses of the photoconductor drums 1, values to be written, that is, the usable surface-layer film thickness values T of the photoconductor drums 1 need to be changed to proper values.

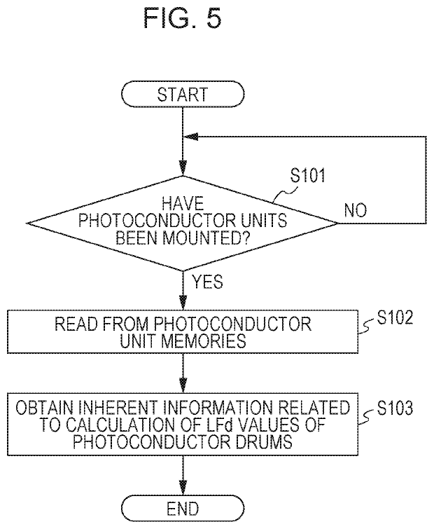

Here, a flow chart for describing control according to the first embodiment (series of steps related to obtaining inherent information related to the calculation of the lifetime value of each photoconductor unit 110) is shown in FIG. 5. The control in FIG. 5 is executed as a result of the controller 20 reading a control program stored in each storage unit of the image forming apparatus 100 and controlling various types of devices. The flowchart of the control in FIG. 5 is started after it is detected that the photoconductor units 110 have been mounted on the mounting portions of the image forming apparatus 100.

When it is detected that the photoconductor units 110 have been mounted on the mounting portions of the image forming apparatus 100 (Step S101; YES), the process proceeds to Step S102. In contrast, when it is detected that the photoconductor units 110 have not been mounted on the mounting portions of the image forming apparatus 100, Step S101 is repeated.

The controller 20 reads pieces of information stored in the photoconductor unit memories 25 (Step S102) and obtains inherent information (for example, information about the coefficients α and β and information about the usable film thickness values of the photoconductor drums 1) related to the calculation of LFd values of the photoconductor drums 1 (lifetime values of the photoconductor units 110) (Step S103). After Step S103, the series of steps according to FIG. 5 ends.

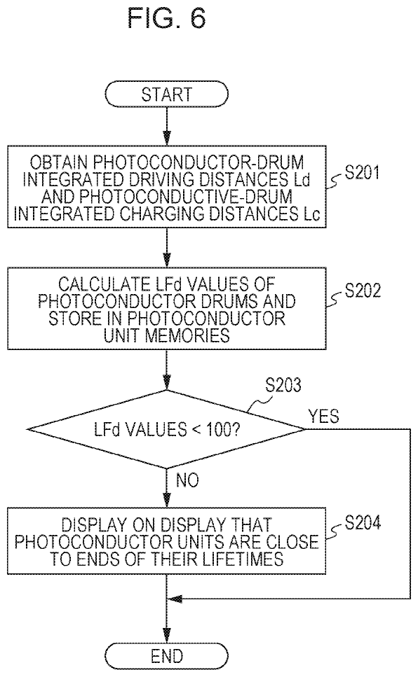

Next, a flow chart for describing control according to the first embodiment (series of steps related to detecting the lifetimes of the photoconductor units 110) is shown in FIG. 6. The control in FIG. 6 is executed as a result of the controller 20 reading a control program stored in each storage unit of the image forming apparatus 100 and controlling various devices. The flowchart of the control in FIG. 6 is started after image forming operations end.

The controller 20 obtains the photoconductor-drum-1 integrated driving distances Ld and the photoconductor-drum-1 integrated charging distances Lc of the photoconductor drums 1, which have been calculated by the integrating unit 210 (Step S201). The controller 20 also calculates the LFd value of each photoconductor drum 1 by using Formula 1 described above from the information about the coefficients α and β and the information about the usable film thickness values of the photoconductor drums 1, which have been obtained in Step S102 of FIG. 5, and from the information about the photoconductor-drum-1 integrated driving distances Ld and the photoconductor-drum-1 integrated charging distances Lc, which have been obtained in Step S201. Then, the controller 20 stores the calculated photoconductor-drum-1 life (LFd) values in the photoconductor unit memories 25 (Step S202).

Next, the controller 20 determines whether the LFd values stored in the photoconductor unit memories 25 are greater than or equal to lifetime threshold values previously set in the photoconductor unit memories 25 (Step S203). In the first embodiment, since the lifetime threshold values are 100%, in Step S203, it is determined whether the LFd values are less than 100%.

When the LFd values are less than 100% (Step S203: YES), the series of steps according to FIG. 6 ends and the process proceeds to a normal image formation waiting state. In contrast, when the LFd values have reached 100% (Step S203: NO), the information related to the lifetimes of the photoconductor units 110 (specifically, for example, information indicating that the photoconductor units 110 are close to the ends of their lifetimes and notification prompting replacement of the photoconductor units 110) is displayed on the display 240 (Step S204).

It should be noted that although, in the first embodiment, when the LFd values have reached 100%, for example, the display 240 is set to display a notification prompting replacement of the photoconductor units 110, the disclosure is not limited thereto.

For example, a structure that triggers automatic transport of a photoconductor unit 110 as a replacement and a structure in which the display 240 regularly displays the LFd values of the photoconductor drums 1 (lifetime values of the photoconductor units 110) by various displaying methods, such as a % displaying method or a memory displaying method, may be modifications.

Although, in the first embodiment, an example in which the lifetimes of the photoconductor units 110 are detected by using, as use information that numerically indicates operating conditions of the photoconductor drums 1, the photoconductor-drum-1 integrated driving distances Ld and the photoconductor-drum-1 integrated charging distances has been described, the disclosure is not limited thereto. For example, a structure in which the integrated number of rotations of the photoconductor drums 1 is used as the information related to the operations of the photoconductor units 110 may be a modification.

In the first embodiment described above, even if the lifetime values of the photoconductor units 110 change after producing and shipping the image forming apparatus 100, the lifetimes of the photoconductor units 110 can be precisely estimated from the inherent information about the photoconductor units 110 stored in the photoconductor unit memories 25.

According to the first embodiment, since the lifetimes of the photoconductor units 110 can be detected by considering the inherent information related to the calculation of the lifetime values of the photoconductor units 110 stored in the photoconductor unit memories 25, it is possible to prompt the replacement of the photoconductor units 110 at a suitable timing.

### Second Embodiment

Since a structure of an image forming apparatus 100 of a second embodiment is similar to that of the above-described first embodiment, the details thereof are not described. In the above-described first embodiment, the lifetimes of the photoconductor units 110 are calculated by estimating the wearing of the photoconductor drums 1. In contrast, the second embodiment differs from the first embodiment in that the lifetimes of photoconductor units 110 are calculated by estimating contaminations of charging rollers 2.

In the second embodiment, the image forming apparatus 100 includes a unit that detects distances obtained by integrating driving distances, obtained by a calculating unit 230, through which the charging rollers 2 are rotationally driven (hereunder referred to as “charging-roller-2 integrated driving distances Dt”). A controller 20 is capable of causing the charging-roller-2 integrated driving distances Dt calculated by an integrating unit 210 to be stored in photoconductor unit memories 25. The controller 20 is also capable of causing a display 240 to display various pieces of information such as information related to the lifetimes of the photoconductor units 110 (for example, notification prompting replacement of the photoconductor units 110).

### Method of Detecting Lifetimes of Charging Rollers

A method of detecting the lifetimes of the photoconductor units 110 according to the second embodiment is described. In the second embodiment, the lifetimes of the photoconductor units 110 are detected by estimating contaminations of the charging rollers 2.

That is, in the second embodiment, the lifetimes of the photoconductor units 110 are calculated by estimating the contamination amounts of external additives of the charging rollers 2. The contamination amounts of the external additives of the charging rollers 2 are calculated by using charging-roller-2 rotation distances Lr, high-charging-voltage-applied charging-roller-2 distances Lc, and various coefficients (γ, δ) stored in the photoconductor unit memories 25. The charging-roller-2 rotation distances Lr and the high-charging-voltage-applied charging-roller-2 distances Lc, obtained by the calculating unit 230, are pieces of information related to the operations of the photoconductor units 110. Allowable values P of the contamination amounts of the external additives are previously set for the charging rollers 2, and the photoconductor units 110 are determined as having reached the ends of their lifetimes when the calculated contamination amounts of the external additives of the charging roller 2 have reached the allowable values P.

The photoconductor unit memories 25 store pieces of inherent information based on the life values (lifetime values) of the photoconductor units 110 (inherent information related to the calculation of the lifetime values of the photoconductor units 110).

In the second embodiment, as the pieces of inherent information related to the calculation of the lifetime values of the photoconductor units 110, at least the following values are stored at the stage of producing the photoconductor units 110.

The coefficients stored in each photoconductor unit memory 25 include the coefficient γ indicating the relationship between the high-charging-voltage-applied charging-roller-2 distance Lc and the contamination amount of the external additive of the charging roller 2. The coefficient γ indicates the rate of contamination of the external additive of each charging roller 2 to the charging-roller-2 rotation distance when a high charging voltage is applied to each charging roller 2.

The coefficients stored in each photoconductor unit memory 25 include the coefficient δ indicating the relationship between the distance through which the charging roller 2 rotates when a high charging voltage is not applied to the charging roller 2 and the contamination amount of the external additive of the charging roller 2. The coefficient δ indicates the rate of contamination of the external additive of each charging roller 2 to the charging-roller-2 rotation distance when a high charging voltage is not applied to each charging roller 2.

Each photoconductor unit memory 25 stores the allowable amount P of the contamination amount of the external additive of the charging roller 2.

The coefficients (γ, δ) stored in the photoconductor unit memories 25 and the allowable values P of the contamination amounts of the external additives determine the values written to the photoconductor unit memories 25 based on structures related to the contamination amounts of the external additives of the charging rollers 2 of the photoconductor units 110. The structures related to the contamination amounts of the external additives of the charging rollers 2 refer to, for example, the surface layer materials and the surface roughness of the charging rollers 2 and the materials and the contact pressures of cleaning blades 61. That is, when producing the photoconductor units 110, by adjusting the values written to the photoconductor unit memories 25 (inherent information related to the calculation of the lifetime values of the photoconductor units 110), it is possible to estimate proper lifetimes based on the lifetime values of the photoconductor units 110.

Life values LFr indicating the states of use of the charging rollers 2 (lifetime values of the photoconductor units 110) are defined by the following Formula 2:

LFr={γ×Lc+δ×(Lr−Lc)}/P×100[%]. . . (2)

Here, Lr−Lc is obtained by subtracting each high-charging-voltage-applied charging-roller-2 distance Lc from each charging-roller-2 rotation distance Lr, and indicates the distance through which each charging roller 2 rotates when a high charging voltage is not applied to each charging roller 2.

That is, γ×Lc is the contamination amount of each charging roller 2 determined by the distance through which a high charging voltage is applied to each charging roller 2, and δ×(Lr−Lc) refers to the contamination amount of each charging roller 2 determined by the distance through which each charging roller 2 rotates when a high charging voltage is not applied to each charging roller 2.

γ×Lc+δ×(Lr−Lc), which is the sum of the aforementioned values, becomes the contamination amount of each charging roller 2, and the proportion of the contamination amount of each charging roller 2 to the allowable value P of the contamination amount of the external additive of each charging roller 2 is the life value LFr indicating the state of use of each charging roller 2.

In the second embodiment, when LFr=100[%], a controller 20 (CPU) determines that the photoconductor units 110 have reached the ends of their lifetimes, and the display 240 displays a warning (notification prompting replacement of the photoconductor units 110).

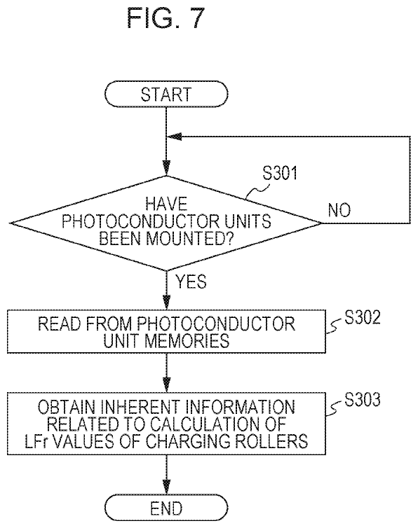

Here, a flow chart for describing control according to the second embodiment (series of steps related to obtaining inherent information related to the calculation of the lifetime values of the photoconductor units 110) is shown in FIG. 7. The control in FIG. 7 is executed as a result of the controller 20 reading a control program stored in each storage unit of the image forming apparatus 100 and controlling various types of devices. The flowchart of the control in FIG. 7 is started after it is detected that the photoconductor units 110 have been mounted on mounting portions of the image forming apparatus 100.

When it is detected that the photoconductor units 110 have been mounted on the mounting portions of the image forming apparatus 100 (Step S301; YES), the process proceeds to Step S302. In contrast, when it is detected that the photoconductor units 110 have not been mounted on the mounting portions of the image forming apparatus 100, Step S301 is repeated.

The controller 20 reads pieces of information stored in the photoconductor unit memories 25 (Step S302) and obtains inherent information (for example, information about the coefficients γ and δ and information about the allowable value P of the contamination amount of the external additive of each charging roller 2) related to the calculation of the LFr value of each charging roller (lifetime value of each photoconductor unit 110) (Step S303).

After Step S303, the series of steps according to FIG. 7 ends.

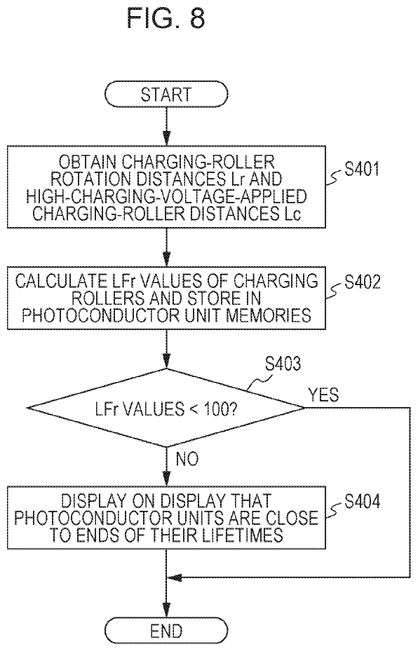

Next, a flow chart for describing control according to the second embodiment (series of steps related to detecting the lifetimes of the photoconductor units 110) is shown in FIG. 8. The control in FIG. 8 is executed as a result of the controller 20 reading a control program stored in each storage unit of the image forming apparatus 100 and controlling various types of devices. The flowchart of the control in FIG. 8 is started after image forming operations end.

The controller 20 obtains the charging-roller-2 rotation distances Lr and the high-charging-voltage-applied charging-roller-2 distances Lc, which have been calculated by the calculating unit 230 (Step S401). The controller 20 also calculates the LFr value of each charging roller 2 by using Formula 2 described above from the inherent information obtained in Step S302 of FIG. 7 (the information about the coefficients γ and δ and the information about the allowable amount P), and from the information (Lr, Lc) obtained in Step S401. Then, the controller 20 stores the calculated charging-roller-2 life (LFr) values in the photoconductor unit memories 25 (Step S402).

Next, the controller 20 determines whether the LFr values stored in the photoconductor unit memories 25 are greater than or equal to lifetime threshold values previously set in the photoconductor unit memories 25 (Step S403). In the second embodiment, since the lifetime threshold values are 100%, in Step S403, it is determined whether the LFr values are less than 100%.

When the LFr values are less than 100% (Step S403: YES), the series of steps according to FIG. 8 ends and the process proceeds to a normal image formation waiting state. In contrast, when the LFr values have reached 100% (Step S403: NO), the information related to the lifetimes of the photoconductor units 110 (specifically, for example, information indicating that the photoconductor units 110 are close to the ends of their lifetimes and notification prompting replacement of the photoconductor units 110) is displayed on the display 240 (Step S404).

It should be noted that although, in the second embodiment, when the LFr values have reached 100%, for example, the display 240 is set to display a notification prompting replacement of the photoconductor units 110, the disclosure is not limited thereto.

For example, a structure that triggers automatic transport of a photoconductor unit 110 as a replacement and a structure in which the display 240 regularly displays the LFr values of the charging rollers 2 (lifetime values of the photoconductor units 110) by various displaying methods, such as a % displaying method or a memory displaying method, may be modifications.

Although, in the second embodiment, an example in which the contamination amounts of the charging rollers 2 are estimated by using, as use information that numerically indicates operating conditions of the charging rollers 2, the charging-roller-2 rotation distances Lr and the high-charging-voltage-applied charging-roller-2 distances has been described, the disclosure is not limited thereto. For example, a structure in which toner print rate information is used to estimate the contamination amounts of the charging rollers 2 may be a modification.

In the second embodiment described above, even if the lifetime values of the photoconductor units 110 change after producing and shipping the image forming apparatus 100, the lifetimes of the photoconductor units 110 can be precisely estimated from the inherent information about the photoconductor units 110 stored in the photoconductor unit memories 25.

According to the second embodiment, since the lifetimes of the photoconductor units 110 can be detected by considering the inherent information related to the calculation of the lifetime values of the photoconductor units 110 stored in the photoconductor unit memories 25, it is possible to prompt replacement of the photoconductor units 110 at a suitable timing.

### Other Examples

The disclosure is not limited to the above-described embodiments, and thus various modifications (including organic combinations of the embodiments) based on the gist of the disclosure are possible and such modifications are not excluded from the scope of the disclosure.

In the above-described embodiments. although, as shown in FIG. 1, the image forming apparatus 100 having a structure including the intermediate transfer belt 51 has been described as an example, the disclosure is not limited thereto. The disclosure is applicable to an image forming apparatus having a structure in which transfer operations are performed by causing transfer media P to directly contact the photoconductor drums 1 in turn.

### Other Embodiments

Embodiments of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-074981, filed Apr. 28, 2025, which is hereby incorporated by reference herein in its entirety.

What is claimed is:

1. An image forming apparatus comprising:
a mounting portion on which a first unit and a second unit are mountable, the first unit including a first member on which a first latent image is to be formed, a first charging member that charges the first member, and a first storage unit, the second unit including a second member on which a second latent image is to be formed, a second charging member that charges the second member, and a second storage unit;
an application unit;
a display; and
a controller that controls the display,
wherein the first storage unit stores first information related to calculation of a first lifetime value of the first unit, and
the second storage unit stores second information related to calculation of a second lifetime value of the second unit, and
wherein in a case where the first unit is mounted on the mounting portion, the application unit applies a voltage to the first charging member, and the controller controls the display to display information related to replacement of the first unit based on the first information stored in the first storage unit and information related to a first operation of the first unit, and
in a case where the second unit is mounted on the mounting portion, the application unit applies a voltage to the second charging member, and the controller controls the display to display information related to replacement of the second unit based on the second information stored in the second storage unit and information related to a second operation of the second unit.

2. The image forming apparatus according to claim 1, wherein
the information related to the first operation is a first charging distance through which the first member is charged by the first charging member, and
the information related to the second operation is a second charging distance through which the second member is charged by the second charging member.

3. The image forming apparatus according to claim 1, wherein
the information related to the first operation is a first charging distance through which the first member is charged by the first charging member and a third driving distance through which the first member is driven, and
the information related to the second operation is a second charging distance through which the second member is charged by the second charging member and a fourth driving distance through which the second member is driven.

4. The image forming apparatus according to claim 1, wherein
the first information includes a coefficient indicating a relationship between a first charging distance through which the first member is charged by the first charging member and a wear amount of the first member, and
the second information includes a coefficient indicating a relationship between a second charging distance through which the second member is charged by the second charging member and a wear amount of the second member.

5. The image forming apparatus according to claim 1, wherein
the first information includes a coefficient indicating a relationship between a first charging distance through which the first member is charged by the first charging member and a wear amount of the first member, and a coefficient indicating a relationship between a value and the wear amount of the first member, the value being obtained by subtracting the first charging distance through which the first member is charged by the first charging member from a first driving distance through which the first member is driven, and
the second information includes a coefficient indicating a relationship between a second charging distance through which the second member is charged by the second charging member and a wear amount of the second member, and a coefficient indicating a relationship between a value and the wear amount of the second member, the value being obtained by subtracting the second charging distance through which the second member is charged by the second charging member from a second driving distance through which the second member is driven.

6. The image forming apparatus according to claim 1, wherein the first information and the second information are different information.
